(19) United States
(12) Patent Application Publication
(10) Pub. No.: US 2019/0383775 A1
(43) Pub. Date: Dec. 19, 2019

(54) APPARATUSES AND METHODS FOR DETERMINING DENSITY OF INSULATION

(71) Applicant: Owens Corning Intellectual Capital, LLC, Toledo, OH (US)

(72) Inventors: James William Rinne, Granville, OH (US); Robert J. O'Leary, Newark, OH (US); Paul Machacek, Toledo, OH (US); Kevin Herreman, Newark, OH (US); Harry Alter, Granville, OH (US)

(21) Appl. No.: 15/735,669

(22) PCT Filed: Jun. 16, 2015
(86) PCT No.: PCT/US15/36065

§ 371 Date: Sep. 17, 2018

(51) Int. Cl. G01N 29/11; G01N 29/04

(52) U.S. Cl. CPC G01N 29/11; G01N 29/223; G01N 29/043

(57) ABSTRACT

Various apparatuses and methods for use in determining the density of insulation in a building cavity are provided. The density of the insulation can then be used for determining the R-value of the insulation. An insulation density measuring apparatus includes a sound wave source and a sound detecting device, such as a microphone, for measuring the sound wave attenuation of a sound wave that moves between the sound wave source and the sound detecting device through the insulation. The sound wave attenuation measurement is correlated with an insulation density.

### RELATED APPLICATIONS

This application is the U.S. national stage entry of PCT/US2015/036065, filed on Jun. 16, 2015 and titled APPARATUSES AND METHODS FOR DETERMINING DENSITY OF INSULATION, the entire disclosure of which is fully incorporated herein by reference.

### TECHNICAL FIELD

This application relates to various apparatuses and methods for determining the density of insulation, and in particular, to apparatuses and methods for determining the density of loose-fill, fibrous insulation.

### BACKGROUND

In recent years, a greater emphasis has been placed on the use of insulation materials in dwellings or other structures to promote both energy conservation and noise reduction. While conventional fibrous batting or blanket insulation is often used for these purposes, the size and shape of internal building cavities do not always lend themselves to the use of conventional fibrous batting, which is often available in batts or rolls of uniform width. In addition, it can be difficult or inconvenient to use conventional fibrous batting to insulate some internal building cavities due to low accessibility or other issues.

For these reasons, techniques have been developed for applying insulation that do not use conventional fibrous batting. For example, various blown-in-place insulation techniques have been developed that use loose-fill insulation that is blown into a building cavity, such as between the framing members of the walls, ceilings, or floors of a building. Such loose-fill insulation can provide a low cost installation technique and can be used fill building cavities of irregular shapes and sizes to achieve a uniform volume of insulation for optimum energy conservation, as well as sound insulation purposes. Typically loose-fill insulation is made of glass fibers although other mineral fibers, organic fibers, and cellulose fibers can also be used.

While blown-in-place insulation techniques can provide a low cost method of installing insulation and can be used to fill building cavities of irregular shapes and sizes, it can be more difficult to determine the thermal resistance or “R-value” of blown-in-place fibrous insulation than with conventional fibrous batting. Building insulation products are quantified by their ability to retard heat flow. Resistance to heat flow or R value is the most common measure of an insulation product's ability to retard heat flow from a structure. The R-value can be determined by the thickness (T) of the fibrous insulation and the (thermal conductivity) insulation constant (k) using the following equation:

$$R = \frac{k}{T} ,$$

where the R-value is resistance to heat flow in hrft2° F./Btu (m2° C./Watt); t is thickness in inches; and k is thermal conductivity in Btu in/hrft2° F. (Watt/m° C.).

During the manufacture of conventional fiberglass insulation batts it is common to utilize the nominal thickness of the insulation batt and the insulation constant to determine the R-value of the batt. This R-value is then often times printed on the batt or the packaging therefor. When insulation batting is purchased, for example, to place in a new dwelling or other building, it is often purchased by specifying a desired R-value. If such conventional insulation is installed in accordance with prescribed installing techniques, the insulation can be relied upon to have a insulation value having a certain thermal resistance due to the uniform dimensions of the insulation batting.

The value of the (thermal conductivity) insulation constant (k) in the equation above used to determine the R-value of insulation is dependent upon the density of the insulation. The density of conventional fiberglass insulation batts is typically relatively constant and easy to determine. However, with blown-in-place, loose-fill, fibrous insulation techniques, the density of the loose-fill insulation located in a building cavity once it has been blown in place can vary. Consequently, it is necessary to determine the density of the blown-in-place insulation to determine the R-value of the insulation. Therefore, it is often necessary to employ some technique for determining the density of blown-in-place insulation to assure that the insulation has a desired R-value.

Various techniques have been used for determining the density of blown-in-place fibrous insulation. For example, in one such technique, a known mass of loose-fill is blown into a cavity of a known volume. The mass is divided by the cavity volume to determine the density and, in turn, the R-value. This technique may not be easy to employ for various reasons, however. For example, it may slow down the installation process. In addition, it may difficult to calculate the actual volume of a building cavity due to lack of accessibility or the inability or difficulty to measure the cavity because of features such as windows, doors, or devices that are located in the building cavity. Furthermore, during the process of blowing the insulation in place, the insulation installers may not provide an even volume filling density that causes the density (and, consequently, the R-value) to vary within one building cavity or from cavity to cavity.

In accordance with an additional known technique, a building cavity space is first filled with blown-in-place insulation. Then, a sample of insulation of a known volume is removed from the cavity and weighed. Using the volume of the insulation sample, it is possible to determine the density of the insulation in the cavity by weighing the sample and dividing the weight by the known volume. Using this density value, the R-value of the insulation may then be determined using conventional methods taking into account the thickness of the insulation in the cavity. This can be a very time consuming technique, however, and consequently is not preferred by insulation installers. Furthermore, in some instances, the insulation may be loose or compressed in certain areas of the cavity from which it is sampled. Consequently, errors in determining the density of the insulation can arise if care is not taken to correctly remove the sample or average a number of samples.

In many conventional methods used for applying blown-in-place, loose-fill, fibrous insulation, netting is secured to wall studs to enclose an underlying cavity. Insulation is then blown into the cavity through one or more holes or apertures in the netting and the netting retains the insulation in the cavity. In an additional known technique used for determining the density of blown-in-place fibrous insulation, the bulging out of this netting in response to the pressure of the insulation retained in the netting is observed as a signal that a sufficient amount of insulation has been fed into the cavity behind the netting. However, this technique is unreliable because it is based on the subjective observation of the insulation installer and the tension of the netting applied to the cavities. Moreover, the mechanical properties such as the modulus of elasticity of the netting material affect the resiliency of the netting and the appearance of the bulge. In addition, the modulus of elasticity of the insulation, which is affected by the fiber diameter and the presence or absence of a binder, controls the resiliency of the insulation. Environmental conditions, such as humidity, may also affect the accuracy of the technique. Another disadvantage of this technique is that installers, in an effort to insure that a cavity is adequately filled, often overfill the cavity. Overfilling the cavity is undesirable because it causes the netting to bulge too much and wastes insulation. If the netting bulges too much, wallboard is difficult to install on the framing members. This has been recognized as a problem and thus has led to the use of a shield during installation, whereby the shield is held against the netting while the cavity is being filled to prevent the netting from bulging undesirably.

In accordance with additional known techniques, apparatuses are used that include a force sensing sensor that is held against blown-in-place, loose-fill, fibrous insulation within a building cavity to determine the force exerted by the insulation against the sensor, such as the apparatuses disclosed in U.S. Pat. Nos. 7,752,889; 7,743,644; 7,712,350; and 6,928,859. U.S. Pat. Nos. 7,752,889; 7,743,644; 7,712,350; and 6,928,859 are each incorporated by reference in their entirety. This force value can then be used to determine the density of the insulation, which, in turn, can be used to determine the R-value of the insulation. In yet additional known techniques, apparatuses such as the INSPECT-R® insulation density gauge provided by Owens Corning are used that include an air cup mounted to a fixture that is pressed against blown-in-place, loose-fill, fibrous insulation within a building cavity, such as the apparatuses disclosed in U.S. Pat. Nos. 7,752,889; 7,743,644; 7,712,350; and 6,928,859. A pressure differential between the air cup and the atmosphere is produced by introducing air into the air cup by a pressure device, such as a conventional air compressor. Using this air pressure differential, the density of the insulation can be determined using known techniques, such as predetermined equations for determining the relationship between the air pressure differential and the density of the insulation. The density can then be used to determine the R-value of the insulation. Such apparatuses can be difficult to use and manipulate, however. For example, such devices can be difficult to hold in a raised position to measure the density of insulation in overhead building cavities such as attic spaces. Furthermore, many such devices often require an air compressor which may be unavailable or can be heavy, bulky and difficult to transport.

### SUMMARY

The present application discloses various apparatuses and methods for use of determining the density of insulation in a building cavity. The density of the insulation can then be used for determining the R-value of the insulation. In one exemplary embodiment, an insulation density measuring apparatus includes a sound wave source and a sound detecting device, such as a microphone. In various such embodiments, the sound wave source and the sound detecting device are combined as a unitary sound transceiver device. In an exemplary method, the density of the insulation is determined by inserting the sound wave source and microphone of the exemplary apparatus into insulation, measuring the sound attenuation as the sound wave moves between the sound wave source and the microphone through the insulation, and correlating this sound attenuation measurement with a insulation density.

In additional exemplary embodiments, the apparatus includes a device that includes a gas source for use in injecting a gas into insulation within a building cavity and gas sensor for detecting the gas. In some such embodiments, a fan is provided that either pulls or draws the gas from the gas source to the sensors. In an exemplary method, the density of insulation is determined by inserting the gas source of the exemplary apparatus into the insulation, releasing gas from the gas source, measuring the travel time of the gas through the insulation located between the gas source and the gas sensor and/or the diffusion or dispersion of the gas between the gas source and the gas sensor, and using this information to determine the density of the insulation.

In additional exemplary embodiments, the apparatus includes a device that includes a light source for emitting calibrated light and a light intensity capture device for detecting light emitted by the light source. In some such embodiments, the apparatus is configured to interface with a conventional mobile phone, tablet or other handheld computing device. In an exemplary method, the density of insulation is determined by inserting the light source of the exemplary apparatus into insulation, emitting calibrated light from the light source which passes through the insulation located between the light source and the light intensity capture device, and measuring the intensity of the light detected by the light intensity capture device. Statistical image analysis is then used to determine the density of the insulation based on the light intensity.

In additional exemplary embodiments, the apparatus includes a device that includes an source, such as a fan, mounted to a fixture that is pressed against blown-in-place, loose-fill, fibrous insulation within a building cavity and an ammeter for measuring the current being supplied to the air source. In an exemplary method, the density of insulation is determined using the exemplary apparatus by measuring the electric current supplied to the air source by a fixed voltage source. This electric current measurement can then be correlated to a density value for the insulation using statistical analysis methods.

In additional exemplary embodiments, the apparatus includes a device that is inserted into the loose-fill insulation and includes one or more members that are selectively driven or moved within the insulation to measure the opposing force or resistance against the movement of the device by the loose-fill insulation. In some such embodiments, the apparatus includes a pair of members that are forced away from one another to measure the opposing force of the insulation. In yet additional embodiments, the apparatus includes a pair of members that are clamped towards one another to measure the opposing force of the insulation. In an exemplary method, the density of insulation is determined using the exemplary apparatus by inserting the apparatus into the insulation and selectively moving the one or more members relative to the insulation to determine the opposing force or resistance of the loose-fill insulation against the movement of the one or more members. Statistical analysis is then used to correlate the opposing force of the insulation surrounding the apparatus to a density measurement for the insulation.

In additional exemplary embodiments, the apparatus includes an inflatable device that is inserted into the loose-fill insulation and inflated within the insulation by using a known volume of air or other gas. In an exemplary method, the density of insulation is determined using the exemplary apparatus by inserting the inflatable device into the insulation, selectively inflating the inflatable device using a known volume of air or other gas and determining the pressure within the inflatable device. Statistical analysis is then used to determine the density of the insulation based upon the pressure within the inflatable device.

Various objects and advantages will become apparent to those skilled in the art from the following detailed description of the invention, when read in light of the accompanying drawings. The accompanying drawings, which are incorporated in and constitute a part of the instant application, illustrate embodiments exemplifying the general inventive concepts of the invention, and together with the description, serve to explain the principles of the general inventive concepts. It is to be expressly understood, however, that the drawings are for illustrative purposes and are not to be construed as defining the limits of the invention.

### BRIEF DESCRIPTION OF THE DRAWINGS

FIG. 1 is a schematic illustration, in plan view, of a portion of a building structure, such as a dwelling;

FIG. 2 is a schematic illustration, in plan view, of a first exemplary embodiment of an apparatus for determining insulation density;

FIG. 3 is a schematic illustration, in plan view, of a second exemplary embodiment of an apparatus for determining insulation density;

FIG. 4 is a perspective view of a third exemplary embodiment of an apparatus for determining insulation density;

FIG. 5 is a perspective view of the exemplary apparatus for determining insulation density illustrated in FIG. 4;

FIG. 6 is a perspective view of the exemplary apparatus for determining insulation density illustrated in FIGS. 3 and 4 being used by a user;

FIG. 7 is a schematic illustration, in plan view, of a fourth exemplary embodiment of an apparatus for determining insulation density;

FIG. 8 is a schematic illustration, in plan view, of a fifth exemplary embodiment of an apparatus for determining insulation density;

FIG. 9 is a rear view of the exemplary apparatus for determining insulation density illustrated in FIG. 8;

FIG. 10 is a front view of the exemplary apparatus for determining insulation density illustrated in FIG. 8;

FIG. 11 is a side, elevational view of the exemplary apparatus for determining insulation density illustrated in FIG. 8;

FIG. 12 is a schematic illustration, in plan view, of a sixth exemplary embodiment of an apparatus for determining insulation density;

FIG. 13 is a front view of a seventh exemplary embodiment of an apparatus for determining insulation density, with the pivoting members in the retracted position;

FIG. 14 is a front view of the exemplary apparatus for determining insulation density illustrated in FIG. 12, with the pivoting members in the deployed position;

FIG. 15 is a schematic illustration, in plan view, of a eighth exemplary embodiment of an apparatus for determining insulation density, with the pivoting members in the first and second position;

FIG. 16 is a schematic illustration, in plan view, of a ninth exemplary embodiment of an apparatus for determining insulation density; and

FIG. 17 is a graph of the relationship between predicted density of unbonded loose fill (ULF) insulation material obtained using exemplary embodiment of apparatus for determining insulation density illustrated in FIG. 2 compared to actual density measurement of same unbonded loose fill (ULF) insulation material.

FIG. 18 is a graph of the relationship between predicted density of batts of insulation material obtained using exemplary embodiment of apparatus for determining insulation density illustrated in FIG. 2 compared to actual density measurement of same batts of insulation material.

FIG. 19 is a graph of the relationship between insulation density and internal balloon pressure measured using exemplary embodiment of apparatus for determining insulation density illustrated in FIG. 16.

### DETAILED DESCRIPTION OF THE INVENTION

The general inventive concepts of the present invention will now be described with occasional reference to the specific exemplary embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art and are not intended to limit the scope of the general inventive concepts of the present invention in any way.

Except as otherwise specifically defined herein, all terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figures disclose various apparatuses and methods for use of determining the density of insulation in a building cavity. Generally, the apparatuses and methods relate to the determination of the density of loose-fill, fibrous insulation. The term “loose-fill insulation”, as used herein, is defined to mean any pourable or blowable insulation material.

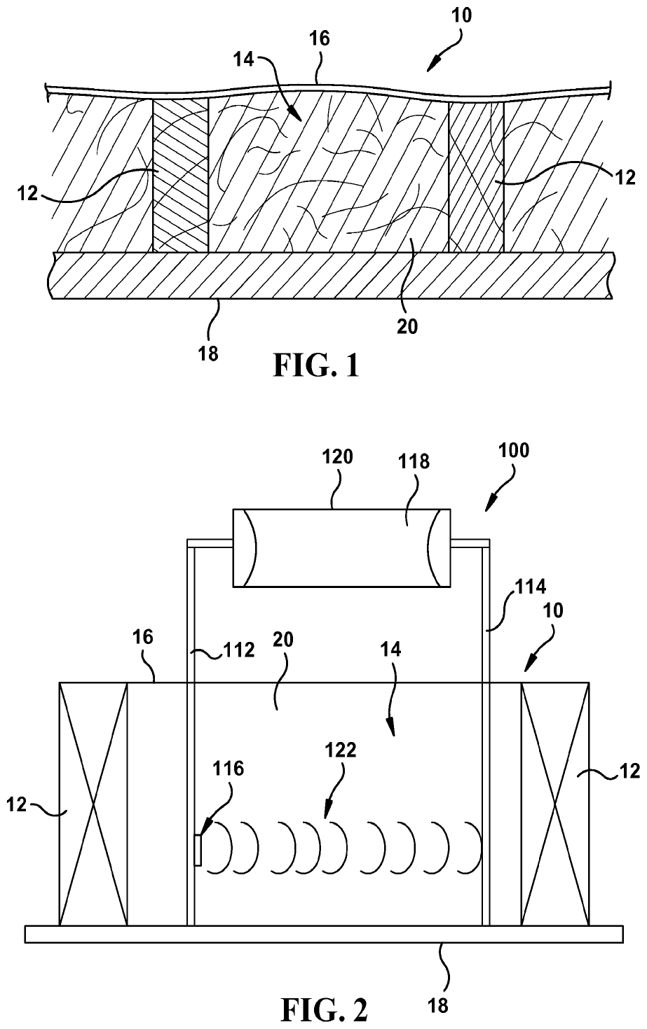

Referring now to the drawings, FIG. 1 illustrates a portion of a building structure 10, which includes framing members 12, such as wall studs, ceiling joists, or floor joists. Various other framing members that are not shown, such as sill plates, headers, etc., may be included in the structure 10, the purpose of which will be apparent to those skilled in the art. A cavity 14 is formed between framing members 12. An inner side of the cavity 14 is covered with a sheet, netting or other material 16. An outer side of the cavity 14 is covered with an exterior sheathing 18, which sheathes the structure 10 except at locations of doors and windows, not shown.

Insulation 20 is installed in the cavity 14 to prevent heat passage either outwardly or inwardly through the structure, and to minimize sound transmission therethrough. The insulation 20 is preferably a loose-fill insulation. The insulation 20 may consist of any suitable material useful for insulation purposes. Such insulation 20 may be installed in a conventional manner, such as through use of a blower apparatus, not shown, which delivers the insulation in an air stream to the cavity 14 through a tube or hose, also not shown.

The netting 16 is configured to contain the insulation 20 in the cavity 14 to hold the insulation 20 in place, and serves to permit air to escape from the cavity 14 while filling the cavity 14 with insulation 20. The netting 16 terminates at lower and upper ends of the cavity 14 at framing members, such as a sill plate and a header, not shown, that traverse the framing members 12. In various embodiments of cavity 14, netting 16 or sheathing 18 or framing members 12, may not be included.

Referring now to FIG. 2, a first exemplary embodiment of an apparatus 100 for determining the density of insulation 20 is illustrated schematically. The apparatus 100 generally includes a pair of probes 112, 114, at least one sound wave source 116, such as a speaker, at least one sound wave detector or sound detecting device 118, such as a microphone, and a main housing 120.

Main housing 120 of apparatus 100 may have any size, shape and configuration and be constructed of any material that allows a user to grasp and manipulate apparatus 100. Probes 112, 114 extend from main housing 12 and are sized, shaped and configured to be inserted through netting 16 and into the insulation 20 in cavity 14. Probes 112, 114 of apparatus 100 are spaced apart. The distance between the probes may vary in various embodiments. The probes 112, 114 of the illustrated embodiment of apparatus 100 are constructed from metal, but any suitable material may be used. The probes 112, 114 may be solid or hollow or include both hollow sections and solid sections. The probes 112, 114 may have any suitable size, shape and configuration. For example, the probes may have a circular or square cross-sectional shape. At least one of the probes 112, 114 serves as a sound wave communicating probe for transmitting a sound wave received from the sound wave source 116 to the other of the pair of probes 112, 114. At least one of the probes 112, 114 serves as a sound wave receiving probe for receiving the sound wave transmitted from the other of the pair of probes 112, 114 and communicating the sound wave to the sound detecting device 118.

The sound wave source 116 of the illustrated exemplary embodiment of apparatus 100 is mounted on or within probe 112. The sound wave source may be a speaker or any other suitable device that emits an ultrasound, audible, infrasound or other type of sound wave. In various additional embodiments, the sound wave source 116 may be located within the main housing 120 of apparatus 100 or in some other portion of the apparatus 100 that is operatively connected with the probe 112 in a way that allows a sound wave 116 to be passed from the sound wave source to one or more of the probes 112, 114 for transmission to the other of the two probes, such as, for example, by way of a tube having a length designed for optimized output energy or other similar device. One or more apertures or holes (not shown) may be defined within probe 112 to allow sound wave 122 to exit probe 112. The sound wave source 116 emits a sound wave 122 of a single known frequency (up to a full spectrum of frequencies) that is communicated to probe 112 and then directed from probe 112 towards probe 114. For example, in various embodiments, the sound wave may have a frequency of 500, 100, or 200 Hz, alone or in combination, or any other suitable frequency. In various embodiments of apparatus 100, the frequency of the sound wave may be selected optionally from various frequencies or is otherwise adjustable. In various embodiments, one of the probes 112, 114 may be driven to vibrate at a selected frequency to create sound wave 116 and be otherwise configured to actually serve as the sound wave source itself. The sound wave source 116 may be any suitable device that emits an ultrasound, audible, infrasound or other type of sound wave, such as a speaker, piston-phone, air pressure device, piezoelectric device, or ultrasonic exciter. While one sound wave source 116 is included with the illustrated embodiment, additional embodiments of apparatus 100 may include more than one sound wave source.

The sound detecting device 118 of the illustrated exemplary embodiment of apparatus 100 is mounted on or within main housing 120 of apparatus 100. The sound detecting device 118 may be a microphone, accelerometer, annamometer, shear wave transducer, PVdF transducer, piezo-ceramic transducer, HIFU transducer or any other suitable device that detects ultrasound, audible, or infrasound waves. The sound detecting device 118 is operatively connected with probe 114 in a way that allows the sound wave 122 emitted from the sound wave source 116 to be detected by probe 114 and then transmitted to the sound detecting device 118. One or more apertures or holes (not shown) may be defined within probe 114 to allow sound wave 122 to enter probe 114. For example, probe 114 may vibrate in response to the sound wave 122 emitted from sound wave source 116 and these vibrations of probe 114 may be detected by the sound detecting device 118. In various additional embodiments, the sound detecting device 118 may be located on or within probe 114 and directly receive the sound waves emitted from the sound wave source 116. If a transducer or similar device is used as the sound detecting device, the transducer would convert a pressure wave into an electronic signal that would be analogous to the sound pressure level of the wave received by the sound detecting device.

While one sound detecting device 118 is included with the illustrated embodiment, additional embodiments of apparatus 100 may include more than one sound detecting device. For example in various embodiments, a sound detecting device 118 may be located on or within each probe 112, 114. A sound wave may be transmitted from the sound wave source 116 directly to a first one of the sound detecting devices located on or within one of the probes by travelling within the probe to the sound detecting device. The sound wave may then be transmitted from this probe across the gap through insulation 20 to the other probe and be received by a second sound detecting device in the other probe. The sound wave received by the first sound detecting device may be compared to the sound wave received by the second sound detecting device to determine the attenuation of the sound wave (or the difference in sound pressure levels) as it moves through the insulation.

To determine the density of insulation 20 with apparatus 100 once the insulation 20 has been blown into cavity 14, the probes 112, 114 of the insulation density measuring apparatus 100 are inserted through netting 16 and into the insulation 20 to a suitable depth within cavity 14 for obtaining a reading, as shown in FIG. 2. The probes 112, 114 may be inserted into the insulation 20 to a full depth that allows the probes 112, 114 to contact sheathing 18 or may only be inserted into the insulation 20 a portion of the full depth between netting 16 and sheathing 18.

Once the probes 112, 114 have been inserted into the insulation 20 a sufficient depth, the sound wave source 116 is activated. The sound wave source 116 may be electronically activated by any suitable mechanism, such as a trigger, switch, etc. Upon activation of the sound wave source 116, a sound wave 122 of a specified frequency or an identified band or bands of frequencies travels through the insulation 20 and reaches probe 114. The response of probe 114 to sound wave 122 is detected by sound detecting device 118. For example, probe 114 may vibrate in response to sound wave 112 and these vibrations may be detected by sound detecting device 118. While the illustrated embodiment of apparatus 100 includes two probes, additional embodiments may be provided with any number of probes, such as such as one probe, two probes, three probes, four probes, or more. For example, some such embodiments may include multiple pairs of probes (i.e., four, six, eight, etc. total probes) and be configured so that sound waves travel between the two probes that make up each of the pair of probes. The measurements made by each such pair of probes could then be averaged to determine an average density measurement over a selected area of insulation or could be used as the basis of other calculations regarding the insulation being analyzed.

Apparatus 100 measures the attenuation of the sound wave (or the difference in sound pressure levels) by comparing the sound wave 122 that reaches probe 114 to the sound wave 122 that is emitted by the sound wave source 116. In addition, in various embodiments, the time that it takes sound wave 122 to travel from the sound wave source 116 to probe 114 may also be measured by apparatus 100. The sound wave 122 that travels through insulation 20 and traverses the gap between probes 112 and 114 will be attenuated based upon the density of insulation 20. In addition, the sound wave 122 may also be attenuated due to additional factors, such as the temperature, atmospheric pressure, humidity, etc. of the area surrounding the apparatus 100 and other factors. In various embodiments, the apparatus 100 may include one or more sensors for sensing temperature, humidity, atmospheric pressure and other atmospheric conditions so that these factors can be taken into account in determining the density of the insulation 20. The attenuation of the sound wave 122 may also be affected by additional factors related to the insulation 20, such as the insulation's material makeup and any binder that may be used with the insulation and these factors can also be taken into account when determining the density of insulation 20.

Using the laws of physics as applied to acoustic attenuation, statistical analysis methods, such as polynomial regression, and/or other known methods, a relationship exists between the attenuation of the sound wave 122 and the density of insulation 20. For example, the density of insulation 20 can be determined using analysis and theories related to acoustic prorogation in a porous or elastic medium, acoustic attenuation, statistical analysis methods, and/or other known methods. For example, techniques discussed in Noise and Vibration Control; Leo L. Beranek, Section 15.1.1, pp. 477-485, McGraw Hill Higher Education, (Jan. 1, 1971), the contents of which are incorporated herein by reference, may also be used to determine the insulation density 20, including the following equation:

$${ρ}_{ULF} = \frac{{ρ}_{air} {c}_{air} \sqrt{10 \frac{Δ P}{10} - 1}}{π fd }$$

Where ΔP=the difference in sound pressures between sound wave source and sound detecting device (dB); d=distance between probes 112, 114; f=frequency (Hz); and c=speed of sound (m/s). In addition, techniques discussed in Generalized Theory of Acoustic Propagation in Porous Dissipative Media; M. A. Biot, The Journal Of The Acoustical Society Of America, Vol. 34, No. 5, PART 1, 1254-1264, September, 1962, the contents of which are incorporated herein by reference, may also be used to determine the insulation density 20. For an insulation 20 having a fixed fiber diameter and a fixed distance from sound wave source 116 to sound detecting device 118, the attenuation is exponentially proportional to the density of the insulation 20 between the probes 112, 114. In this way, the density of the insulation 20 can be determined with apparatus 100 by measuring the attenuation of sound wave 122 of a specified frequency as it travels a set distance through insulation 20 across the gap between probes 112 and 114. Once the density has been determined for the insulation 20, the R value for the insulation can then be determined using known methods.

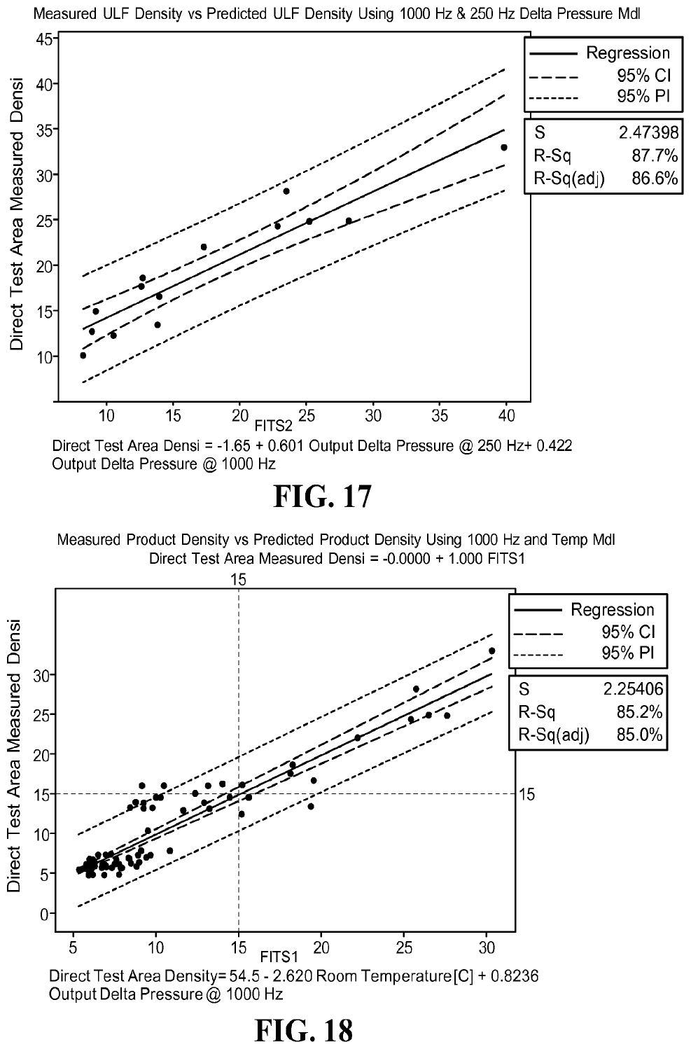

For example, FIG. 17 is a graph that charts the predicted density of unbonded loose fill (ULF) insulation material obtained using exemplary apparatus 100 and the equation above (with a distance between probes 112, 114 of 10 inches; and using sound waves of both 1000 Hz and 250 Hz) compared to the actual density measurement of the same unbonded loose fill (ULF) insulation material located between probes 112, 114.

FIG. 18 is a graph that charts the predicted density of insulation material in batt form obtained using exemplary apparatus 100 and the equation above (with a distance between probes 112, 114 of 10 inches; and using sound waves of 1000 Hz) compared to the actual density measurement of the same insulation material in batt form.

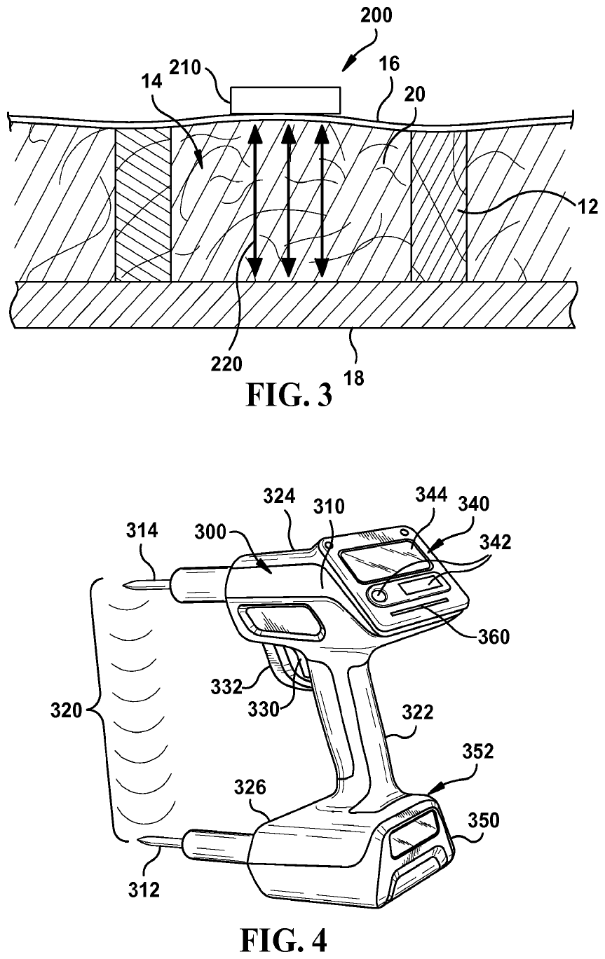

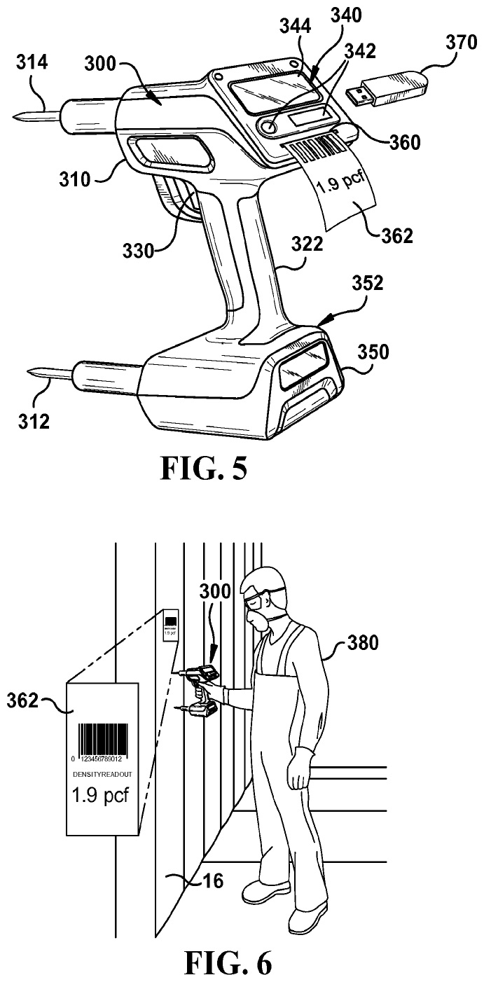

In various additional embodiments, an apparatus may be provided that includes a device that both transmits and receives sound waves (i.e., a sound transceiver device). For example, referring now to FIG. 3 a second exemplary embodiment of an apparatus 200 for determining the density of insulation 20 that includes a sound transceiver device 210 is illustrated schematically. The illustrated embodiment of apparatus 200 is configured to be placed against netting 16 at the air/insulation interface. Sound transceiver device 210 is configured to both transmit and receive a sound wave and can be any suitable device that emits and receives an ultrasound, audible, or infrasound wave.

As illustrated in FIG. 3, the sound transceiver device 210 emits a sound wave 220 that travels through insulation 20 and contacts sheathing 18. The sound wave is reflected off of sheathing 18 and returns to the sound transceiver device 210. The attenuation of the sound as it passes through the insulation 20 is determined by comparing the sound wave originally emitted by the sound transceiver device 210 to the sound wave that is received by the sound transceiver device 210. In addition, the duration of time for the sound wave to be transmitted from the sound transceiver device 210, travel through the insulation, be reflected off of the sheathing 18, and return to the sound transceiver device 210 may also be measured.

Using the laws of physics as applied to acoustic attenuation, statistical analysis methods, such as polynomial regression, and/or other known methods, a relationship can be found between the attenuation of the sound wave 122 and the density of insulation 20. In this way, the density of the insulation 20 can be determined. Once the density has been determined for the insulation 20, the time it takes the sound wave to return to the sound transceiver device 210 at specific frequencies can be utilized to determine the depth of the insulation and thus the R value for the insulation can then be determined using known methods. In various additional embodiments, the sound transceiver device 210 of apparatus 200 may be a mobile phone, with the transmitter of the mobile phone serving to transmit the sound wave and the receiver of the mobile phone serving to receive the sound wave.

Referring now to FIG. 4, a third exemplary embodiment of an apparatus 300 for determining the density of insulation 20 is illustrated. Apparatus 300 is a handheld device that generally includes a main housing 310 and a pair of probes 312, 314 projecting from the main housing 310. The a main housing 310 of the illustrated embodiment of apparatus 300 includes a handle portion 322 disposed between an upper portion 324 and lower portion 326, all of which are formed integrally as a unitary construction. In some exemplary embodiments, handle portion 322, upper portion 324 and/or lower portion 326 may be separate pieces that are attached or otherwise fastened (e.g., using screws, bolts, rivets) together or to one or more portions of the main housing 310. The main housing 310, handle 322, upper portion 324 and lower portion 326 may be manufactured by any suitable method, including any one of a variety of methods of manufacture that are well known in the art. For example, a variety of molding processes could be used. In various embodiments of the general inventive concepts, the components of apparatus 300, including main housing 310, handle 322, upper portion 324 and lower portion 326 may be made from one or a combination of materials, such as thermoplastic or elastomeric materials selected for desirable properties, such as durability, lightweight, scratch and abrasion resistance, etc. Various embodiments may be constructed from durable materials to withstand the harsh conditions of a building construction site or other difficult environment. The size, shape and configuration of the apparatus 300 and components thereof are adapted for ease of portability and use.

The handle portion 322 is configured to fit within and be grasped by the hand of a user to allow a user to hold, carry and manipulate apparatus 300. In some exemplary embodiments, the handle 322 may include one or more projections, ridges or other formations or be otherwise shaped or configured to fit within the hand of a user more ergonomically. In some exemplary embodiments, the handle 322 includes one or more portions formed from a non-slip or cushioned material, such as a rubber or elastomeric material, to provide for a more comfortable or non-slip grip when being held by a user. In some exemplary embodiments, more than one handle is provided and in yet additional embodiments no handle is provided.

An activation mechanism 330, such as a trigger, extends from the main housing 310 and is partially enclosed by a trigger guard 332 projecting from the main housing 310 and extending from the handle portion 322 to the upper portion 324. The trigger 330 is pressed by a user to activate the apparatus. While the activation mechanism 330 is a trigger in the illustrated embodiment, in various additional embodiments any suitable type of activation mechanism may be provided, such as one or more buttons, dials, toggles, sliders, etc. One or more such activation mechanisms 330 may be provided in various embodiments of the general inventive concepts. In various embodiments, one or more devices may be provided to prevent accidental activation of the activation mechanism 330, such as a lock or a moveable cap that fully or partially covers the activation mechanism 330 until it is moved out of the way by a user because activation is desired.

Probes 312, 314 of apparatus 300 extend from main housing 310 and are sized, shaped and configured to be inserted through netting 16 and into insulation 20 in cavity 14. Probes 312, 314 of apparatus 310 are spaced apart. The distance between the probes may vary in various embodiments. The probes 312, 314 of the illustrated embodiment of apparatus 310 are constructed from metal, but any suitable material may be used. The probes 312, 314 may be solid or hollow or include both hollow sections and solid sections. The probes 312, 314 may have any suitable size, shape and configuration. For example, the probes may have a circular or square cross-sectional shape.

Apparatus 300 includes a sound wave source (not shown). The sound wave source may be a speaker or any other suitable device that emits an ultrasound, audible, infrasound or other type of sound wave. In various embodiments, the sound wave source 116 may be located on or within one or more of the probes 312, 314 or housed within the main housing 310 of apparatus 300 or in some other portion of the apparatus 300 and be operatively connected with one or more of the probes 312, 314 in a way that allows a sound wave 320 to be passed from the sound wave source to one or more of the probes 312, 314 (such as, for example, by way of a tube having a length designed for optimized output energy or other similar device) for transmission to the other of the two probes. The sound wave source emits a sound wave 320 of a single known frequency up to a full spectrum of frequencies from one or more of the probes 312, 314 that is directed towards the other of the two probes. For example, in various embodiments, the sound wave may have a frequency of 500, 100, or 200 Hz, alone or in combination, or any other suitable frequency. One or more apertures or holes (not shown) may be defined within probes 312, 314 to allow sound wave 122 to enter/exit probes 312, 314. In various embodiments of apparatus 300, the frequency of the sound wave may be selected optionally from various frequencies or otherwise be adjustable. In various embodiments, one of the probes 312, 314 may be driven to vibrate at a selected frequency to create sound wave 320 and/or be otherwise configured to actually serve as the sound wave source itself. The sound wave source may be any suitable device that emits an ultrasound, audible, infrasound or other type of sound wave, such as a speaker, piston-phone, air pressure device, piezoelectric device, or ultrasonic exciter. Various embodiments of apparatus 300 may include any number of sound wave sources.

Apparatus 300 also includes a sound detecting device (not shown). The sound detecting device 118 may be a microphone, accelerometer, annamometer, shear wave transducer, PVdF transducer, piezo-ceramic transducer, HIFU transducer or any other suitable device that detects ultrasound, audible, or infrasound waves. In various embodiments, the sound detecting device may be located on or within one or more of the probes 312, 314 or housed within the main housing 310 of apparatus 300 or in some other portion of the apparatus 300 and be operatively connected with one or more of the probes 312, 314 in a way that allows the sound wave 320 emitted from the sound wave source to be detected by one of probes 312, 314 and transmitted to the sound detecting device. For example, one or more of the probes 312, 314 may vibrate in response to the sound wave 320 emitted from sound wave source and these vibrations of the probe may be detected by the sound detecting device. In various additional embodiments, the sound detecting device may be located on or within one or more of probes 312, 314 and directly receive the sound waves emitted from the sound wave source. If a transducer or similar device is used as the sound detecting device, the transducer could convert a pressure wave into an electronic signal that would be analogous to the sound pressure level of the wave received by the sound detecting device.

To determine the density of insulation 20 with apparatus 300 once the insulation 20 has been blown into cavity 14, the probes 312, 314 of the insulation density measuring apparatus 300 are inserted through netting 16 and into the insulation 20 to a suitable depth within cavity 14 for obtaining a reading (without substantially affecting density of insulation 20). The probes 312, 314 may be inserted into the insulation 20 to a full depth that allows the probes 312, 314 to contact sheathing 18 or may only be inserted into the insulation 20 a portion of the full depth between netting 16 and sheathing 18.

Once the probes 312, 314 have been inserted into the insulation 20 a sufficient depth, the sound wave source is activated by a user by trigger 330. Upon activation, the sound wave source emits a sound wave 320 of a specified frequency or an identified band or bands of frequencies that travels from one of the probes 312, 314 to the other probe. The response of the probe receiving the sound wave 320 is detected by the sound detecting device. For example, the probe may vibrate in response to the sound wave 320 and these vibrations may be detected by the sound detecting device. While the illustrated embodiment of apparatus 300 includes two probes 312, 314, additional embodiments may be provided with any number of probes, such as one probe, two probes, three probes, four probes or more. For example, some such embodiments may include multiple pairs of probes (i.e., four, six, eight, etc. total probes) and be configured so that sound waves travel between the two probes that make up each of the pair of probes. The measurements made by each such pair of probes could then be averaged to determine an average density measurement over a selected area of insulation or could be used as the basis of other calculations regarding the insulation being analyzed.

Apparatus 300 measures the attenuation of the sound wave 320 as it travels between probes 312, 314. The attenuation is determined by comparing the sound wave that was emitted by the sound wave source to the sound wave received by the sound detecting device. In addition, in various embodiments, the time that it takes sound wave 320 to travel from the sound wave source to the sound detecting device (i.e., the time it takes sound wave 320 to travel between probes 312, 314) may also be measured by apparatus 300. The sound wave 320 that travels through insulation 20 and traverses the gap between probes 312, 314 will be attenuated based upon the density of insulation 20. In addition, the sound wave 320 may also be attenuated due to additional factors, such as the temperature, atmospheric pressure, humidity, etc. of the area surrounding the apparatus 300 and other factors. In various embodiments, the apparatus 300 may include one or more sensors for sensing temperature, humidity, atmospheric pressure and other atmospheric conditions so that these factors can be taken into account in determining the density of the insulation 20. The attenuation of the sound wave 320 may also be affected by additional factors related to the insulation 20, such as the insulation's material makeup and any binder that may be used with the insulation and these factors can also be taken into account when determining the density of insulation 20.

Using the laws of physics as applied to acoustic attenuation, statistical analysis methods, such as polynomial regression, and/or other known methods, a relationship exists between the attenuation of the sound wave 320 and the density of insulation 20. For example, the density of insulation 20 can be determined using analysis and theories related to acoustic prorogation in a porous or elastic medium, acoustic attenuation, statistical analysis methods, and/or other known methods. For example, techniques discussed in Noise and Vibration Control; Leo L. Beranek, Section 15.1.1, pp. 477-485, McGraw Hill Higher Education, (Jan. 1, 1971), the contents of which are incorporated herein by reference, may also be used to determine the insulation density 20, including the following equation:

$${ρ}_{ULF} = \frac{{ρ}_{air} {c}_{air} \sqrt{10 \frac{Δ P}{10} - 1}}{π fd }$$

Where ΔP=the difference in sound pressures between sound wave source and sound detecting device (dB); d=distance between probes 112, 114; f=frequency (Hz); and c=speed of sound (m/s). In addition, techniques discussed in Generalized Theory of Acoustic Propagation in Porous Dissipative Media; M. A. Biot, The Journal Of The Acoustical Society Of America, Vol. 34, No. 5, PART 1, 1254-1264, September, 1962, the contents of which are incorporated herein by reference, may also be used to determine the insulation density 20. For an insulation 20 having a fixed fiber diameter and a fixed distance between probes 312, 314 (and/or fixed distance between the sound wave source to sound detecting device), the attenuation is exponentially proportional to the density of the insulation 20 between the probes 312, 314. For an example, a predetermined equation providing the relationship between the sound attenuation and the density of insulation 20 may be used. In this way, the density of the insulation 20 can be determined with apparatus 300 by measuring the attenuation of sound wave 320 having a specified frequency as it travels a set distance through a known insulation type across the gap between probes 312, 314. Once the density has been determined for the insulation 20, the R value for the insulation can then be determined using known methods.

The illustrated embodiment of apparatus 300 includes a user interface 340 on main body 310 that includes one or more controls 342 and a display screen 344. Controls 342 are used by a user to control the operation of apparatus 300 and input data. A variety of control types of any number may be provided in various embodiments, including buttons, switches, keypads, knobs, etc. In various additional embodiments, the apparatus 300 may include one or more touch sensitive screens that allows a user to control apparatus and input data via touching virtual buttons on the touch screen.

Apparatus 300 includes one or more measuring device, internal processing device, memory device, hardware, firmware, software and/or combinations of each (not shown) to perform functions or actions, and/or to cause a function or action from another component of apparatus 300 (not shown) for use in processing various user inputs and data resulting from measurements performed by apparatus 300 and to execute various analytical and calculation procedures and steps to generate a variety of desired types of data and information and to store measured data, user inputted data and other information. The software that may be included with apparatus includes but is not limited to one or more computer readable and/or executable instructions that cause a computer or other electronic device within apparatus 300 to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a user or the like.

The illustrated embodiment of apparatus 300 may include an optional Global Positioning System (GPS) receiver or other location identifying device to identify, gather and store information regarding the location of the apparatus 300. For example, in various embodiments, apparatus 300 may gather location information at the time each density measurement is taken and link such location information with each density measurement taken by apparatus 300. Such location information and density measurement may further be linked with time and date information associated with the density measurement. Such density measurement, location related information and time/date information may be linked together and stored in the memory device of apparatus 300.

This combined location, time/date and density measurement information and other information measured by apparatus 300 or input into apparatus 300 can be used to decrease a user's ability to produce falsified density readings in an effort to create a record that a higher density of insulation was installed in a particular building cavity than actually was. For example, if the time/date information associated with a particular density reading taken by apparatus 300 does not correspond with the time/date that the user was on location at a building site in question and/or the location information associated with a particular density reading taken by apparatus 300 does not correspond with the location where the density measurements were supposed to be taken, this would indicate that the density readings may not be authentic. This method of associating location information and time/date information with each density measurement could be utilized to authenticate or validate that density measurements taken with apparatus 300 are authentic and verifiable and, as a result, be used to deter users from falsifying density measurements to give the impression that a higher density of insulation was installed than desired or to give the impression that density measurements had been taken at a particular desired location when no such measurements had actually been taken.

The data and information that is stored in and/or processed by apparatus 300 may be displayed to a user via display screen 344. For example, the one or more measuring device, internal processing device, memory device, hardware, firmware, software and/or combinations of each (not shown) apparatus 300 may be used to measure, calculate, determine, store and/or display (via the display screen 344) measured data, user inputted data and/or other information including, a sound wave attenuation value corresponding to the attenuation of the sound wave traversing the gap between probes 312, 314, insulation density, density variation between a measurement and a previously taken measurement or measurements, density variation between a measurement and a preselected density target, information related to the running average of density measurements taken by apparatus 300 during a defined period of time or a defined number of density measurements, running average of density variation, number of measurements taken, battery charge level, date and time related information, information related to current job (i.e., address, builder, insulation type, sq. ft, insulation bag count, etc.), information about the user(s) (i.e., identifying information for inspector, installer, etc.), R-value target requested from builder, contractor, etc., data pertaining to different insulation types for use in converting density measurements into R-value for a given insulation type, information regarding location where measurements were taken, etc.

Apparatus 300 is powered by a power source 350. In the illustrated embodiment of apparatus 300, the power source is a removable, rechargeable battery 350 that is releasably received within a battery receiving portion 352 of main body 310. In various additional embodiments, additional power source types may be utilized, such as an internal, un-removable rechargeable battery, or the apparatus 300 may be a corded device that is plugged into a power source. In various embodiments, apparatus 330 may be provided with a recharging cradle or station (not shown) for recharging the rechargeable battery 350. In various embodiments, apparatus 300 may be configured to interface and operate with commercially available rechargeable batteries, such as standard batteries that may be sold and/or compatible with other commercially available handheld, cordless tools, such as handheld drills, sanders, saws, flashlights, etc. This would allow for replacement batteries to be easily acquire by a user, should the originally provided battery become lost or damaged.

The illustrated embodiment of apparatus 300 includes a printing device 360 that is housed within the main body 310. Printing device 360 is used to print out desired or preselected data on paper, labels, adhesive stickers or other media 362. Printing device 360 may be controlled by a user using controls 342 or may be programmed to automatically print out specified information for each density reading that is taken with apparatus 300. The printouts 362 printed by printing device 360 may include a variety of types of information, such as information regarding the time, date and location where the measurement was taken and the individual/company responsible for taking the measurement to provide evidence that a measurement was taken, and document the density of the insulation for the builder, inspector, a Residential Energy Services Network's Home Energy Rating System (HERS®) index standard rater, or other interested parties. Additional embodiments of apparatus 300 may be provided without a printing device 360.

As illustrated in FIG. 6, printed labels 362, including a variety of preselected information, such as density measurement, time/date and location of measurement, or other information may printed out by a user 380. In accordance with various exemplary methods of using the apparatus 300, such labels 362 may be printed using apparatus 300 and adhered to various locations at a job site where density measurements were taken. Such labels 362 may be used to provide evidence that a measurement was taken, and document the density of the insulation for the builder, inspector, a Residential Energy Services Network's Home Energy Rating System (HERS®) index standard rater, or other interested parties. In various embodiments, this information can be coded as a bar-code or other machine readable code that can be read by a scanner or other device used by an inspector or other individual to confirm the measurements that were taken by quickly scanning the bar code on label 362.

The illustrated embodiment of apparatus 300 includes a USB port (not shown), or other hardware interface for attaching peripherals to apparatus 300, for receiving a USB device 370, a USB-to-USB cable, or other computer storage device or medium to allow for data to be loaded into the memory of apparatus 300 or for the transfer of data from the apparatus 300 to an external computer (not shown). For example, data necessary to correlate a given density measurement to an R-value for a particular insulation type may be loaded onto apparatus 300 via USB port. In various embodiments, apparatus 300 may be configured to recognize and accept a license key stored on a USB device that is inserted into the USB port. Upon recognition and acceptance of the license key, the apparatus 300 may be configured to enable or permit a user to access certain preselected functionality or features corresponding to the license key. For example, the apparatus 300 could be configured to only take density measurements of certain insulation types if the license key has been loaded onto the apparatus via USB port. In additional embodiments, apparatus 300 may be configured to only take density measurements for a certain period of time of if certain volume targets are continually met, unless a license key is loaded onto the apparatus via USB port to override, reset or alter these parameters. In various additional embodiments, any data resident on apparatus 300, such as density measurements, etc. may be downloaded from device to a phone, computer or other electronic device using USB port or other hardware interface or Bluetooth or wireless connectivity mechanism.

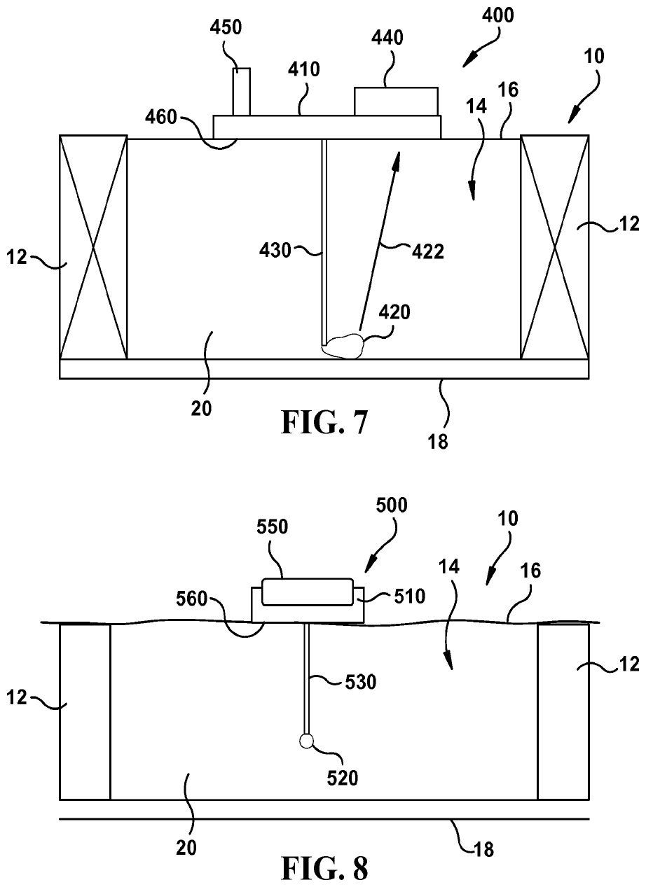

Referring now to FIG. 7, a fourth exemplary embodiment of an insulation density measuring apparatus 400 is illustrated, which generally includes a main body 410, a gas release device, such as a nozzle 420 mounted at the end of an extension arm 430 extending from the main body 410, and a gas sensor 440. Gas release device 420 is configured to be inserted into the insulation 20 in cavity 14 and release gas within the insulation 12. The time it takes the gas to travel from gas release device 420 to gas sensor 440 along path 422 and/or the diffusion or dispersion of the gas as it travels from gas release device 420 to gas sensor 440 is determined by apparatus 400 and this information is used to determine the density of insulation 20.

Main body 410 of insulation density measuring apparatus 400 may have any configuration, shape and size that permits a user to manipulate apparatus 400 so that gas release device 420 can be located within insulation 20 and gas sensor 440 can be located adjacent cavity 14 against the netting 16 and insulation 20. In various embodiments, main body 410 may include one or more grips or handles 450 that allow a user to hold, maneuver and locate apparatus 400.

In various embodiments, main body 410 may include one or more frames, guides, braces and/or other devices (not shown) configured to support and/or locate apparatus 400 in a fixed position relative to netting 16 and insulation 20. For example, in various embodiments, apparatus 400 may include a frame configured to support apparatus 400 adjacent cavity 14 (with insulation 20 located therein) in a manner so that apparatus 400 and gas sensor 440 can be repeatedly held in a fixed potion relative to cavity 14 each time a density measurement is desired. The main body 410 and/or gas sensor 440 may be in contact with the netting 16 and insulation 20 in this fixed position or spaced apart from the netting 16 and insulation 20. It is beneficial for the position of apparatus 400 relative to netting 16 and the insulation 20 to be consistent from measurement to measurement to permit correlated determinations of density. To locate apparatus 400 consistently from measurement to measurement, in various embodiments, apparatus 400 may be configured to be located in a fixed position by optional legs that extend outwardly from the main body 410 to engage the framing members 12, although such legs are not required. Furthermore, apparatus 400 may be configured so that underside 460 of main body 410 is consistently located in a plane that is generally coplanar with the inner sides of the framing members 12 (i.e., generally coincides with the plane formed by netting 16) and does not extend into the cavity 14 between the framing members 12.

In various additional embodiments of apparatus 400 may be located consistently from measurement to measurement, by optional pins or legs (not shown) that are adapted to pierce the netting 16, pass through the insulation 20 in the cavity 14 without substantially affecting its density, and engage the inner side of the sheath 18. The length of the pins may be fixed or adjustable to accommodate framing members 12 having different dimensions. For example, the length of the pins may be approximately 3½ inches in length if the framing members 12 are nominal 2×4 studs or approximately 5½ inches in length if the framing members 12 are nominal 2×6 ceiling joists. Adjustment of the pins may be accomplished in any suitable manner, such as, for example, providing apertures, not shown, through the main body 410 and a clamping device in fixed position relative to main body 410 and in alignment with such apertures. The pins may pass through the apertures and the clamping device may secure the pins in a desired position relative to the main body 410. Alternatively, the pins may be telescopically adjustable, or adjustable in some other suitable manner.

In various additional embodiments, extension arm 430 may be utilized to locate apparatus 400 consistently relative to cavity 14 from measurement to measurement and the length of extension arm 430 may be fixed or adjustable to accommodate framing members 12 having different dimensions.

The insulation density measuring apparatus 400 includes a gas supply (not shown), such as one or more gas storage tanks or other gas storage devices for storing gas for being supplied to gas release device 420. A variety of different gases may be used with apparatus 400. Any gas that can be safely stored and released within the insulation and the presence of which can detected by a sensor of some kind can be used. For example, inert gases may be used. It should be understood that a wide variety of gases may be used in various embodiments of apparatus 400, such as argon, neon, helium, nitrogen, carbon dioxide, or other gases.

The insulation density measuring apparatus 400 includes a gas delivery system (not shown) for delivering the gas from the gas supply to gas release device 420 and controlling the release of the gas from the gas release device 420, such as, for example, one or more hoses, controllers, gauges, pressure regulators, valves, purifiers, filters, connectors, or other gas delivery mechanisms and components. In various embodiments, gas supply may be located within main body 410 of apparatus 400 and the gas may be delivered to gas release device 420 by or one or more gas delivery system components located within extension arm 430. In various additional embodiments, extension arm 430 may take the form of a hollow tube used for delivering gas to gas release device 420. Gas delivery system of apparatus 400 may be configured to selectively adjust the pressure of gas delivered to gas release device 420 and released within insulation 20, or the pressure may be regulated at a constant pressure. Gas delivery system of apparatus 400 further includes an activation device, such as a trigger, switch, button, valve or knob, that permits a user to selectively activate the gas delivery system to deliver gas to gas release device 420 and/or to release gas from the gas release device 420. The gas delivery system and gas release device 420 are configured in a manner that permits a user to insert gas release device 420 into insulation 20 in cavity 14 and initiate and/or control the release of gas from gas release device 420 into the insulation 20.

The gas sensor 440 of the illustrated embodiment of apparatus 400 is mounted on or within the main body 410 or other component of apparatus 400 and configured to be in fluid communication with the insulation 20 when apparatus 400 is placed against the netting 16 and insulation 20 to measure the density of insulation 20, which allows the gas sensor 440 to sense gas exiting the insulation 20. In various embodiments of apparatus 400, the gas sensor 440 is located on or within the underside 460 of apparatus 400 and comes in direct contact with the insulation 20 and/or netting 16 when apparatus 400 is being used by a user to make a density measurement. In various additional embodiments, gas sensor 440 is positioned within the main body 410 of apparatus 400 and gas exiting insulation 20 reaches gas sensor 440 by way of one or more vents, ducts, passages, tubes, channels, baffles or other air conveying structures or mechanisms located on or within apparatus 400. The insulation density measuring apparatus 400 may include one or more optional fans or other suction devices (not shown) or series thereof to help withdraw the gas from within insulation 20 and/or to direct gas exiting the insulation 20 to the gas sensor 440.

A variety of different types of gas sensor can be used with apparatus 400. For example, the detection and measurement of the concentration of gas can be made by a variety of different types of gas sensors using a variety of gas detection methods, such as optical absorption methods of gas detection, including but not limited to non-dispersive infrared, spectrophotometry, tunable diode laser spectroscopy and photoacoustic spectroscopy gas detection techniques. Various other methods of gas detection may also be used, such as acoustic, thermal conductivity, gas chromatograph, and calorimetric based gas sensing methods.

Once insulation 20 has been blown into cavity 14, to determine the density of insulation 20 with insulation density measuring apparatus 400, the extension arm 430 and gas release device 420 are inserted through netting 16 and into the insulation 20 to a suitable depth within cavity 14 for obtaining a reading (without substantially affecting density of insulation 20). In various embodiments, extension arm 430 and gas release device 420 may be inserted into the insulation 20 to a full depth that allows extension arm 430 and/or gas release device 420 to contact sheathing 18. In various additional embodiments, gas release device 420 may only be inserted into the insulation 20 a portion of the full depth between netting 16 and sheathing 18. In various embodiments, an optional shield or cage is provided that at least partially encloses gas release device 420 but permits the travel of gas therethrough to prevent or diminish the potential blockage or obstruction of gas release device 420 by insulation 20 as gas release device 420 is inserted into cavity 14 and/or to prevent the gas release device 420 from becoming damaged by contacting sheathing 18 or other surfaces or objects.

Once the gas release device 420 has been inserted into the insulation 20 a sufficient depth, gas release device 420 is activated by a user to release gas within the insulation 20 in cavity 14. Upon activation, the gas release device 420 releases gas within the insulation 20. Apparatus 400 includes at least one measuring device (not shown) configured to determine the time it takes gas to travel from gas release device 420 to gas sensor 440 (i.e., traverse gas travel path 422) and/or the diffusion or dispersion of the gas as it travels from gas release device 420 to gas sensor 440. Any suitable measuring device may be used to make these determinations. With embodiments of apparatus 400 including an optional fan or suction device, the fan or suction device can be configured to create a vacuum that draws the gas towards gas sensor 440 and speeds up the travel of gas along gas travel path 422. While the illustrated embodiment of apparatus 400 includes one gas release device 420 and one gas sensor 440, additional embodiments may be provided with any number of gas release devices 420 and gas sensors 440. The measurements made by each gas sensor could then be averaged or otherwise used or analyzed to calculate the density of insulation 20.

The density of insulation 20 can be determined based upon the gas travel time and/or gas diffusion measurements made by apparatus 400. For example, the density of insulation 20 can be determined based upon the gas travel time and/or gas diffusion measurements by using analysis and theories related to gas propagation in a porous or elastic medium, statistical analysis methods, and/or other known methods. For an example, techniques developed from Fick's laws, which were developed by Adolf Fick in the 19th century, may be used to determine the insulation density using the gas travel time and/or gas diffusion measurements made by apparatus 400. In addition, it should be appreciated by those skilled in the art that Gassmann's equation for fluid substitution may also be utilized to determine the insulation density using the gas travel time and/or gas diffusion measurements made by apparatus 400. In this way, the density of the insulation 20 can be determined with apparatus 400 by measuring the gas travel time and/or gas diffusion as it travels a set distance through a known insulation type across the gap between gas release device 420 and gas sensor 440. Once the density has been determined for the insulation 20, the R value for the insulation can then be determined using known methods.

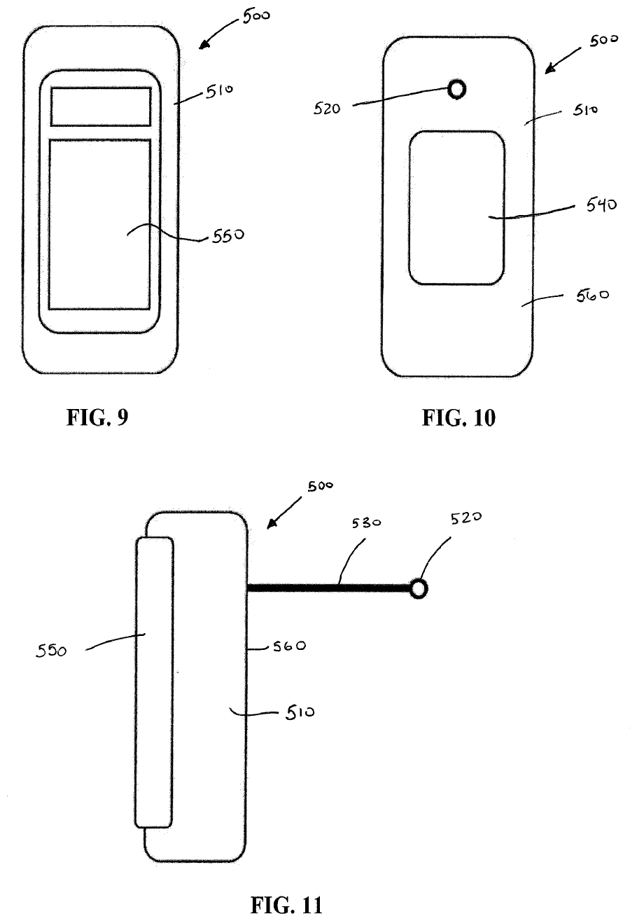

Referring now to FIGS. 8-11, a fifth exemplary embodiment of an insulation density measuring apparatus 500 is illustrated, which generally includes a main body 510, a light source 520 mounted at the end of an extension arm 530 extending from the main body 510, and a light detector 540. Light source 520 is configured to be inserted into the insulation 20 in cavity 14 and release calibrated light within the insulation 12. The intensity of the light captured by light detector 540 is determined and this information is used to determine the density of insulation 20.

Main body 510 of insulation density measuring apparatus 500 may have any configuration, shape and size that permits a user to manipulate apparatus 500 so that light source 520 can be located within insulation 20 and light detector 540 can be located adjacent cavity 14 against the netting 16 and insulation 20. In various embodiments, main body 510 may include one or more grips or handles 550 that allow a user to hold, maneuver and locate apparatus 500.

In various embodiments, main body 510 may include one or more frames, guides, braces and/or other devices (not shown) configured to support and/or locate apparatus 500 in a fixed position relative to netting 16 and insulation 20. For example, in various embodiments, apparatus 500 may include a frame configured to support apparatus 500 adjacent cavity 14 (with insulation 20 located therein) in a manner so that apparatus 500 and light detector 540 can be repeatedly held in a fixed potion relative to cavity 14 each time a density measurement is desired. The main body 510 and/or light detector 540 may be in contact with the netting 16 and insulation 20 in this fixed position or spaced apart from the netting 16 and insulation 20. It is beneficial for the position of apparatus 500 relative to netting 16 and the insulation 20 to be consistent from measurement to measurement to permit correlated determinations of density. To locate apparatus 500 consistently from measurement to measurement, in various embodiments, apparatus 500 may be configured to be located in a fixed position by optional legs that extend outwardly from the main body 510 to engage the framing members 12, although such legs are not required. Furthermore, apparatus 500 may be configured so that underside 560 of main body 510 is consistently located in a plane that is generally coplanar with the inner sides of the framing members 12 (i.e., generally coincides with the plane formed by netting 16) and does not extend into the cavity 14 between the framing members 12.

In various additional embodiments of apparatus 500 may be located consistently from measurement to measurement, by optional pins or legs (not shown) that are adapted to pierce the netting 16, pass through the insulation 20 in the cavity 14 without substantially affecting its density, and engage the inner side of the sheath 18. The length of the pins may be fixed or adjustable to accommodate framing members 12 having different dimensions. For example, the length of the pins may be approximately 3½ inches in length if the framing members 12 are nominal 2×4 studs or approximately 5½ inches in length if the framing members 12 are nominal 2×6 ceiling joists. Adjustment of the pins may be accomplished in any suitable manner, such as, for example, providing apertures, not shown, through the main body 510 and a clamping device in fixed position relative to main body 510 and in alignment with such apertures. The pins may pass through the apertures and the clamping device may secure the pins in a desired position relative to the main body 510. Alternatively, the pins may be telescopically adjustable, or adjustable in some other suitable manner.

In various additional embodiments, extension arm 530 may be utilized to locate apparatus 500 consistently relative to cavity 14 from measurement to measurement and the length of extension arm 530 may be fixed or adjustable to accommodate framing members 12 having different dimensions.

Various light sources 520 may be used with insulation density measuring apparatus 500. In illustrated embodiment of apparatus 500, the light source is a light-emitting diode (i.e., LED) light source that emits calibrated light. However, in additional embodiments, various additional light source types may be utilized, such as an incandescent, tungsten, halogen, fluorescent, high intensity discharge (i.e., HID) or infrared light sources.

The light detector 540 of the illustrated embodiment of apparatus 500 is mounted on or within the main body 510 or other component of apparatus 500 and configured to receive and measure the intensity of light emitted from light source 520. In various embodiments of apparatus 500, the light detector 540 is located on or within the underside 560 of apparatus 500 and comes in direct contact with the insulation 20 and/or netting 16 when apparatus 500 is being used by a user to make a density measurement. In various additional embodiments, light detector 540 is recessed within the main body 510 of apparatus 500 and light exiting insulation 20 reaches light detector 540 by way of one or more filters, lenses, reflectors or other light transmitting devices located on or within apparatus 500.

A variety of different types of light detector 540 can be used with apparatus 500. For example, the detection and measurement of the concentration of gas can be made by a variety of different types of light detectors using a variety of light intensity measuring methods, such as one or more photometers, photoresistors, photodiodes or photomultipliers, quantum sensors, lux meters, thermal power sensors, silicone photodiodes, one or more filters, etc. or any other sensor types or components thereof for sensing and or measuring the intensity of ultraviolet, visible, or infrared light, etc. In various additional embodiments, a heat emitting probe and infrared or other heat detecting sensor could be utilized in place of the light source and light sensor.

The illustrated embodiment of apparatus 500 is configured and adapted to receive a conventional mobile phone, tablet or other handheld computing device 550. In various embodiments, handheld computing device 550 is used to allow a user to interface with and operate and/or control apparatus 550. In various embodiments, a software application or “app” may be provided, which is to be downloaded onto the handheld device for use in operating apparatus 500. In various additional embodiments, apparatus 500 may be configured to use the flash device used with the camera function of the handheld computing device 550 as the light source or to use the camera of the handheld computing device 500 as the light detector 540.

To determine the density of insulation 20 with insulation density measuring apparatus 500 once insulation 20 has been blown into cavity 14, the extension arm 530 and light source 520 are inserted through netting 16 and into the insulation 20 to a suitable depth within cavity 14 for obtaining a reading (without substantially affecting density of insulation 20). In various embodiments, extension arm 530 and light source 520 may be inserted into the insulation 20 to a full depth that allows extension arm 530 and/or light source 520 to contact sheathing 18. In various additional embodiments, light source 520 may only be inserted into the insulation 20 a portion of the full depth between netting 16 and sheathing 18. In various embodiments, an optional shield or cage is provided that at least partially encloses light source 520 but permits the travel of light therethrough to prevent or diminish the potential blockage or obstruction of light source 520 by insulation 20 as light source 520 is inserted into cavity 14 and/or to prevent the light source 520 from becoming damaged by contacting sheathing 18 or other surfaces or objects.

Once the light source 520 has been inserted into the insulation 20 a sufficient depth, light source 520 is activated by a user to emit calibrated light within the insulation 20 in cavity 14. Light detector 540 of apparatus 500 measures the intensity of the light received by the light detector 540. Apparatus 500 includes at least one measuring device (not shown) for determining the relative light intensity of the light received by light detector 540 by comparing the intensity of the light received by the light detector 540 to the intensity of the light emitted from light source 520. Any suitable measuring device may be used to relative light intensity. While the illustrated embodiment of apparatus 500 includes one light source 520 and one light detector 540, additional embodiments may be provided with any number of light sources 520 and light detectors 540. The measurements made by each light detector 540 could then be averaged or otherwise used or analyzed to calculate the density of insulation 20. Various known methods and statistical image analysis techniques can then be used to determine the density of insulation 20 based upon the intensity of light detected by light detector 540 and/or the comparison of the light intensity of the light received by light detector 540 to the intensity of the light emitted from light source 520, such as, for example, light gradation analysis. Once the density has been determined for the insulation 20, the R value for the insulation can then be determined using known methods.

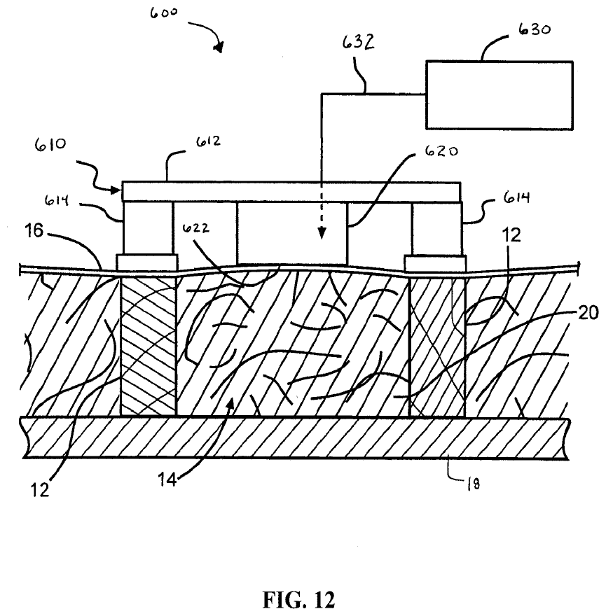

Referring now to FIG. 12, a sixth exemplary embodiment of an insulation density measuring apparatus 600 is illustrated, which generally includes a main body 610, an air source 620, such as a fan, mounted to the main body 610, and power source 630. Fan 620 includes contact surface 622. Apparatus 600 is configured to be placed adjacent cavity 14 in a manner that contact surface 622 of fan 620 is pressed against netting 16 and the insulation 20 in the cavity 14 behind the netting 16.

As shown in FIG. 12, the fan 620 in the illustrated embodiment is mounted to main body 610. Main body 610 is configured to support fan 620 and hold the contact surface 622 of fan 620 in a fixed position relative to the netting 16 and the insulation 20. In the embodiment illustrated in FIG. 12, the main body 610 generally includes a plate 612 and a pair of legs 614 adapted and configured to rest against framing members 12 when apparatus 600 is positioned adjacent cavity 14. In various additional embodiments, the main body 610 could be any suitable structure configured to support the fan 620 and hold the hold the contact surface 622 of fan 620 in a fixed position relative to the netting 16 and the insulation 20. For example, in various embodiments, apparatus 600 may be configured in a manner so that fan 620 can be repeatedly held in a fixed potion relative to cavity 14 each time a density measurement is desired. It is beneficial for the position of apparatus 600 relative to netting 16 and the insulation 20 to be consistent from measurement to measurement to permit correlated determinations of density. For example, apparatus 600 may be configured so that contact surface 622 of fan 620 is consistently located in a plane that is generally coplanar with the inner sides of the framing members 12 (i.e., generally coincides with the plane formed by netting 16) and does not extend into the cavity 14 between the framing members 12. In yet additional embodiments, the fan 620 could be a free standing structure without a main body 610.

As previously mentioned, the contact surface 622 of fan 620 is configured to press against the netting 16 and insulation 20. Apparatus 600 includes an activation device for activating the fan 620. Any suitable activation device may be provided, such as a switch, toggle, trigger, button, knob, etc. Upon activation, power is supplied to the motor of fan 620 via power connector 632 from power source 630 at a constant voltage. Fan 620 is configured to operate at a constant speed (i.e. constant rate of rpm). Apparatus 600 includes at least one measuring device, such as an ammeter (not shown) that is configured to measure the current (in amperes) supplied to fan 620 by power source 630 to operate at this predetermined fixed speed. Any suitable measuring device may be used to determine the current delivered to the fan 620. Various known methods and statistical analysis techniques can then be used to determine the density of insulation 20 based upon the measurement of the current supplied to fan 620. Once the density has been determined for the insulation 20, the R value for the insulation can then be determined using known methods. In various additional embodiments, a fixed current may be supplied to fan 620 and the resulting rpm of the fan may be measured to determine the density of insulation 20.

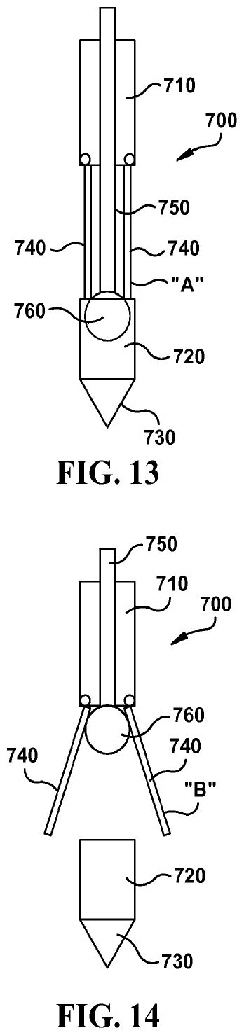

Referring now to FIGS. 13-14, a seventh exemplary embodiment of an insulation density measuring apparatus 700 is illustrated, which generally includes an upper main body portion 710, a lower main body portion 720, a pair of a moveable members 740, and a device 750 for spreading the moveable members 740. Apparatus 700 is configured to be inserted into insulation 20 located in cavity 14 in a manner that moveable members 740 can be selectively moved within insulation 20 from a retracted position “A” to a deployed position “B′ to measure the opposing force or resistance against the movement of the moveable members 740 created by insulation 20.

As shown in FIGS. 13-14, apparatus 700 includes an upper main body portion 710 and a lower main body portion 720. The upper main body portion 710 and lower main body portion 720 are joined together by one or more structural elements or frame members (not shown). Upper main body portion 710 and lower main body portion 720 may have any suitable configuration, shape, size and structure that permits apparatus 700 to be inserted into cavity 14 with moveable members 740 in a retracted position “A” so that movable members 740 can be moved outwardly to a deployed position “B” or otherwise moved relative to the insulation 20 in cavity 14. As illustrated in FIGS. 13-14, lower main body portion 720 of apparatus 700 includes a triangular shaped projection 730, which helps to reduce the resistance experienced by apparatus 700 as it is inserted into insulation 20 and reduce the force necessary to insert apparatus into insulation 20. However, it should be understood that additional embodiments do not include such a triangular shaped projection. Various additional embodiments may take any of a variety of suitable shapes. The triangular projection 730 and/or overall length and dimensions of apparatus 700 may be used to consistently locate apparatus 700 within cavity 14 during each measurement. For example, in various embodiments, apparatus 700 may be configured so that apparatus 700 is inserted into cavity 14 by a user until triangular projection 730 of lower main body portion 720 contacts sheathing 18 to properly locate apparatus 700 relative to cavity 14.

Once apparatus 700 is inserted into insulation 12 in cavity 14, moveable members 740 are moved from the retracted position “A” to a deployed position “B′. The moveable members 740 can be driven to move by any suitable mechanism. Moveable members 740 of apparatus 700 are driven apart by spherical member 760 located on spreading device 750. Spherical member 760 is pulled upwardly by spreading device 750 to drive apart moveable members 740 a known distance. In various additional embodiments, any suitable device can be used to impart a known displacement to moveable members 760 and urge moveable members outwardly. Any suitable powered device may be used to drive spreading device 750, such as a pneumatic or hydraulic cylinder or other device. In various additional embodiments, moveable members 740 are manually moved by a user. Apparatus 700 includes at least one measuring device configured to determine the force necessary to move moveable members 760 a known distance. Any suitable device may be used to measure the force necessary to impart a known displacement to moveable members 740, such as, for example, a force transducer attached to spreading device 750, or other gauge or measuring device. Various known methods and statistical analysis techniques can then be used to determine the density of insulation 20 based upon the measurement of the force applied to moveable members 740 and using the Hookean behavior or linear elasticity properties demonstrated by insulation 20 in cavity 14. Once the density has been determined for the insulation 20, the R value for the insulation can then be determined using known methods.

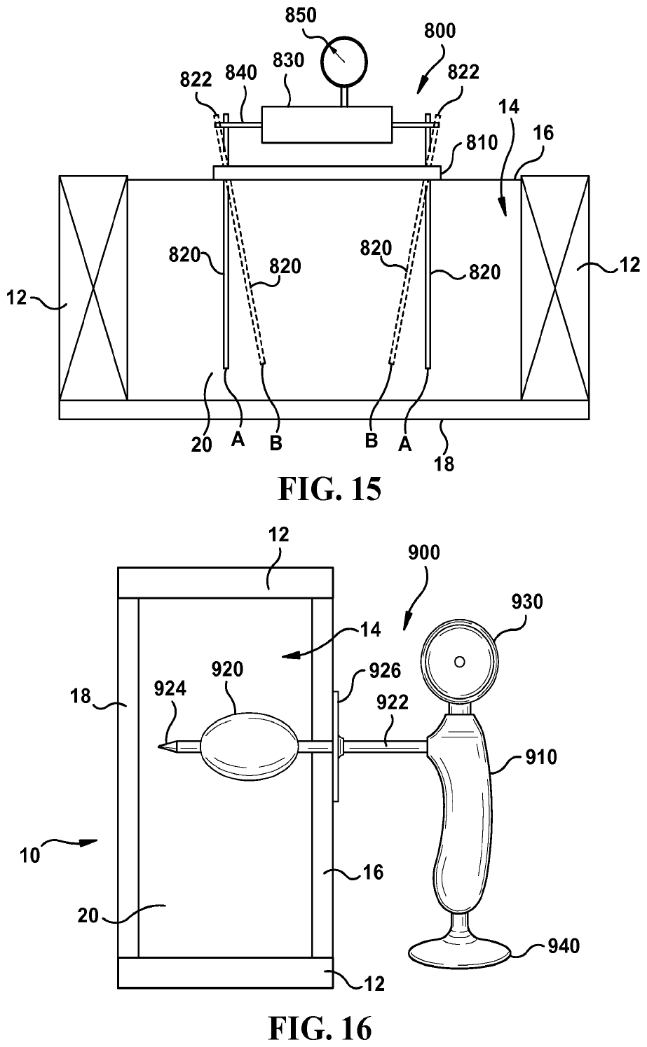

Referring now to FIG. 15, a eight exemplary embodiment of an insulation density measuring apparatus 800 is illustrated, which generally includes a main body portion 810, a pair of a moveable members 820, a device 830 for driving the moveable members 740 to move, and a gauge or other measuring device 850 for measuring the force exerted on the moveable members 740. Apparatus 800 is configured to be inserted into insulation 20 located in cavity 14 in a manner that moveable members 840 can be selectively clamped towards one another within insulation 20 from a first position “A” to a second position “B′ to measure the opposing force or resistance against the movement of the moveable members 840 created by insulation 20.

As shown in FIG. 15, apparatus 800 includes a main body portion 810. Main body portion 810 may have any suitable configuration, shape, size and structure that permits apparatus 800 with moveable members 840 to be inserted into cavity 14 so that movable members 840 can be moved from a first position “A” to a second position “B” or otherwise moved relative to the insulation 20 in cavity 14. The configuration and/or dimensions of main body portion 810 and/or moveable members 840 may be used to consistently locate apparatus 800 within cavity 14 during each measurement. For example, in various embodiments, apparatus 800 may be configured so that apparatus 800 is inserted into cavity 14 by a user until moveable members 840 contact sheathing 18 to properly locate apparatus 700 relative to cavity 14. In various additional embodiments, apparatus 800 may be configured so that apparatus 800 is inserted into cavity 14 by a user until main body member 810 contacts insulation 20 and netting 16 to properly locate apparatus 700 relative to cavity 14. In various additional embodiments, the length of moveable members 840 may be adjustable to accommodate cavities 14 and framing members 12 of various dimensions.

Once apparatus 800 is inserted into insulation 12 in cavity 14, moveable members 820 are moved from a first position “A” to a second position “B”. The moveable members 820 can be driven to move by any suitable mechanism. Upper ends 822 of moveable members 820 of apparatus 800 are driven outwardly by powered device 830. Moveable members are pivotally attached to main body 810 in a way that the outward force applied to upper ends 822 of moveable members 820 by rods 840 of powered device 830 causes moveable members to be urged towards one another within insulation 20 in cavity 14 from a first position “A” to a second position “B”. Any suitable powered device 830 may be used with apparatus, such as a pneumatic or hydraulic cylinder or other device. In various embodiments, moveable members 820 are moved manually by a user. Powered device 830 is used to move moveable members 820 a known distance. Measuring device or gauge 850 measures the force necessary to move moveable members 820 a known distance. Any suitable measuring device may be used to measure the force necessary to impart a known displacement to moveable members 820. Various known methods and statistical analysis techniques can then be used to determine the density of insulation 20 based upon the measurement of the force applied to moveable members 820 and using the Hookean behavior or linear elasticity properties demonstrated by insulation 20 in cavity 14. Once the density has been determined for the insulation 20, the R value for the insulation can then be determined using known methods.

Referring now to FIG. 16, a ninth exemplary embodiment of an insulation density measuring apparatus 900 is illustrated, which generally includes a pump 810 and a balloon 920, or other inflatable device. Balloon 920 is configured to be inserted into the insulation 20 in cavity 14 and inflated or expanded using a known volume of air or other gas. The pressure inside of the balloon 920 is determined and this information is used to determine the density of insulation 20.

In the illustrated embodiment, balloon 920 is mounted of an extension arm 922 that extends from pump 810. Extension arm 922 includes a pointed end 924 to reduce the resistance experienced by extension arm 922 of apparatus 900 as it is inserted into insulation 20 and reduce the force necessary to insert apparatus 900 into insulation 20. However, it should be understood that additional embodiments do not include such a pointed end 924. The extension arm 922 of various additional embodiments may take any of a variety of suitable shapes. The pointed end 924 and/or overall length and dimensions of extension arm 922 of apparatus 900 may be used to consistently locate balloon 920 of apparatus 900 within cavity 14 during each measurement. For example, in various embodiments, apparatus 900 may be configured so that apparatus 900 is inserted into cavity 14 by a user until pointed end 924 of the extension arm 922 contacts sheathing 18 to properly locate apparatus 700 relative to cavity 14. In the illustrated embodiment, a depth guide 926 is provided, which may work in combination with depth measurements or other markings (not shown) made on extension arm 922. With such embodiments, depth guide 926 may be positioned adjacent cavity 14 and a user may insert extension arm 922 into cavity 14 until a desired depth marking on extension arm 922 aligns with depth guide 926 to insert balloon into cavity a desired amount.

Pump 910 of insulation density measuring apparatus 900 may have any configuration, shape and size that permits a user to manipulate pump 910 to inflate balloon 920 within insulation 20 in cavity 14. In various embodiments, Pump 910 may include one or more grips or handles that allow a user to hold, maneuver and locate apparatus 900. Pump 910 of the illustrated embodiment is a manually operated pump including a plunger 940 for inflating the balloon 920, but additional embodiments of apparatus 900 may be provided with powered pumps that are not manually operated.

To determine the density of insulation 20 with insulation density measuring apparatus 500 once insulation 20 has been blown into cavity 14, the balloon 920 (in a deflated state) and extension arm 922 are inserted through netting 16 and into the insulation 20 to a suitable depth within cavity 14 for obtaining a reading (without substantially affecting density of insulation 20). In various embodiments, balloon 920 and extension arm 922 may be inserted into the insulation 20 to a full depth that allows extension arm 922 to contact sheathing 18. In various additional embodiments, balloon 920 and extension arm 922 may only be inserted into the insulation 20 a portion of the full depth between netting 16 and sheathing 18. In various embodiments, an optional shield or cage is provided that at least partially encloses balloon 920 but permits expansion of balloon therein to prevent balloon 920 from becoming damaged or pierced by contacting sheathing 18 or other surfaces or objects.

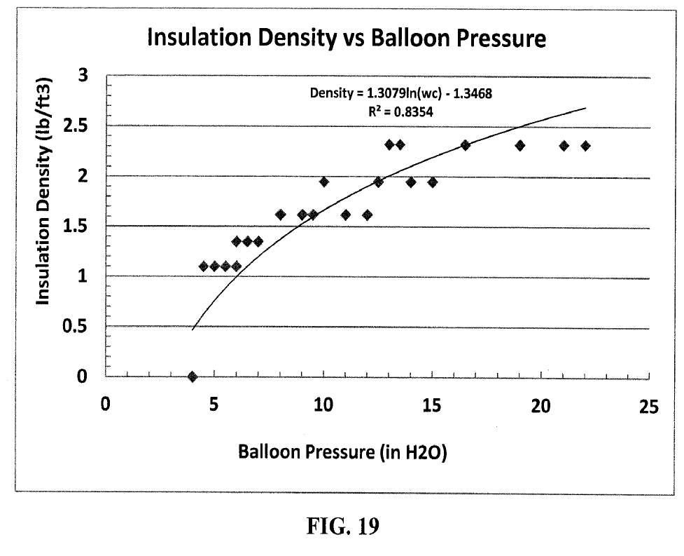

Once the balloon 920 has been inserted into the insulation 20 a sufficient depth, plunger 940 of pump 910 is used by a user to inflate balloon 920 using a fixed volume of air or other gas. In the illustrated embodiment, air travels from pump 910 within extension arm 922 and then enters balloon 920 by way of one or more holes or apertures defined within extension arm 922 that are in communication with balloon 920 to provide an air passageway from pump 910 to balloon 920. The balloon 920 is inflated with a predetermined volume of air by pump 910. For example, a user may press the plunger 940 into pump 910 one full stroke, which will force a set volume of air into balloon 920. In various additional embodiments, various mechanisms may be utilized to meter the air delivered to balloon 920 to deliver a set volume of air into balloon 920. Measuring device or gauge 930 is used to measure the pressure within balloon 920 once a set volume of air has been pumped into balloon 920. This pressure within balloon 920 can be compared to ambient pressure and using various known methods and statistical analysis techniques, the pressure within the balloon can then be used to determine the density of insulation 20 surrounding the balloon 920 within the cavity using the Hookean behavior or linear elasticity properties demonstrated by insulation 20 in cavity 14. A higher density of insulation 20 will exert a higher force upon balloon 920 and result in a higher pressure within balloon 920. Once the density has been determined for the insulation 20, the R value for the insulation can then be determined using known methods. An example of the relationship between internal balloon pressure (inches of water) measured in balloon 920 and insulation density (lb/ft³) is illustrated in the chart included as FIG. 19. Measurements of pressure within a balloon were taken at seven different locations within a tube having a 6 inch radius filled with insulation of various densities (i.e., 1.1, 1.35, 1.62, 1.95 and 2.32 lb/ft³), as follows:

| | Lbs of | Insulation | | Dry pump | Balloon |
|---|---|---|---|---|---|
| | insulation | Density | Balloon | readout for | Pressure |
| Trial # | in Tube | (PCF) | Position | calibration | in H2O |
| 0 | 0 | 0 | | | 4 |
| | 0 | 0 | | | 4 |
| | 0 | 0 | | | 4 |
| | 0 | 0 | | | 4 |
| | 0 | 0 | | | 4 |
| | 0 | 0 | | | 4 |
| | 0 | 0 | | | 4 |
| 1 | 3.5 | 1.1 | 1 | 4 | 5 |
| | 3.5 | 1.1 | 2 | 4 | 5 |
| | 3.5 | 1.1 | 3 | 4 | 5.5 |
| | 3.5 | 1.1 | 4 | 4 | 5.5 |
| | 3.5 | 1.1 | 5 | 4 | 5.5 |
| | 3.5 | 1.1 | 6 | 4 | 4.5 |
| | 3.5 | 1.1 | 7 | 4 | 6 |
| 2 | 4.35 | 1.35 | 1 | 4 | 6 |
| | 4.35 | 1.35 | 2 | 4 | 6 |
| | 4.35 | 1.35 | 3 | 4 | 6 |
| | 4.35 | 1.35 | 4 | 4 | 7 |
| | 4.35 | 1.35 | 5 | 4 | 6.5 |
| | 4.35 | 1.35 | 6 | 4 | 7 |
| 3 | 5.1 | 1.62 | 1 | 4 | 11 |
| | 5.1 | 1.62 | 2 | 4 | 8 |
| | 5.1 | 1.62 | 3 | 4 | 9 |
| | 5.1 | 1.62 | 4 | 4 | 12 |
| | 5.1 | 1.62 | 5 | 4 | 8 |
| | 5.1 | 1.62 | 6 | 4 | 9.5 |
| | 5.1 | 1.62 | 7 | 4 | 9.5 |
| 4 | 6.1 | 1.95 | 1 | 4 | 10 |
| | 6.1 | 1.95 | 2 | 4.5 | 14 |
| | 6.1 | 1.95 | 3 | 4.5 | 14 |
| | 6.1 | 1.95 | 4 | 4.5 | 12.5 |
| | 6.1 | 1.95 | 5 | 4 | 15 |
| | 6.1 | 1.95 | 6 | 4.5 | 10 |
| | 6.1 | 1.95 | 7 | 4.5 | 14 |
| 5 | 7.3 | 2.32 | 2 | 4.5 | 13 |
| | 7.3 | 2.32 | 3 | 4.5 | 13.5 |
| | 7.3 | 2.32 | 4 | 4.5 | 21 |
| | 7.3 | 2.32 | 5 | 4.5 | 16.5 |
| | 7.3 | 2.32 | 6 | 4.5 | 19 |
| | 7.3 | 2.32 | 7 | 4.5 | 22 |
| 6 | 7.3 | 2.32 | 1 | 4.5 | 18 |
| | 7.3 | 2.32 | 2 | 4.5 | 15 |
| | 7.3 | 2.32 | 3 | 4.5 | 16.5 |
| | 7.3 | 2.32 | 4 | 4.5 | 14.5 |
| | 7.3 | 2.32 | 5 | 4.5 | 17.5 |
| | 7.3 | 2.32 | 6 | 4.5 | X |
| | 7.3 | 2.32 | 7 | X | X |

With X representing attempts where balloon pressure could not be determined due to broken balloon or failure to maintain adequate seal between balloon and pump apparatus.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the applicants intend to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the general inventive concepts may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of the general inventive concepts, such identification is not intended to be exclusive, but rather there may be inventive aspects, concepts and features that are fully described herein without being expressly identified as such or as part of the general inventive concepts. Any descriptions of exemplary methods or processes are not limited to inclusion of all steps as being required in all cases, nor is the order that the steps are presented to be construed as required or necessary unless expressly so stated.

While the invention has been illustrated and described in detail in the drawings and foregoing description, the same is to be considered as illustrative and not restrictive in character. It should be understood that only the exemplary embodiments have been shown and described and that all changes and modifications that come within the spirit of the invention are desired to be protected.

In accordance with the provisions of the patent statutes, the principles and modes of the improved apparatuses and methods of measuring the density of insulation have been explained and illustrated in their preferred embodiment. However, it must be understood that the improved method of apparatuses and methods of measuring the density of insulation may be practiced otherwise than as specifically explained and illustrated without departing from its spirit or scope.

1. An apparatus for determining the density of insulation in a cavity, the apparatus comprising:
a sound wave source for emitting a sound wave;
a sound wave detector;
a sound wave communicating probe for insertion into the insulation in the cavity;
a sound wave receiving probe for insertion into the insulation in the cavity; wherein a gap is present between the sound wave communicating probe and the sound wave receiving probe when the probes are located in the insulation within the cavity;
wherein the sound wave source is configured to communicate the sound wave to the sound wave communicating probe;
wherein the sound wave received by the sound wave communicating probe from the sound wave source is directed across the gap to the sound wave receiving probe; wherein the sound wave travels through the insulation that is present in the gap as it travels from the sound wave communicating probe to the sound wave receiving probe; and
wherein the sound wave detector is configured to detect the sound wave received by the sound wave receiving probe.

2. The apparatus of claim 1, wherein the apparatus further comprises a measuring device configured to compare the sound wave emitted from sound wave source to the sound wave detected by sound wave detector to determine a sound wave attenuation value corresponding to the attenuation of the sound wave traversing the gap between the sound wave communicating probe and the sound wave receiving probe.

3. The apparatus of claim 2, wherein the apparatus calculates the density of insulation using the sound wave attenuation value.

4. The apparatus of claim 1, wherein the sound wave source is a speaker.

5. The apparatus of claim 1, wherein the sound wave detector is a microphone.

6. The apparatus of claim 4, wherein apparatus comprises a main body; wherein the sound wave communicating probe projects from the main body; wherein the sound wave source is positioned within the main body and the sound wave is communicated from the sound wave source to the sound wave communicating probe for subsequent communication of the sound wave to the sound wave receiving probe.

7. The apparatus of claim 1, wherein one or more openings are defined in at least one of the sound wave communicating probe and the sound wave receiving probe for allowing the passage of sound wave therethrough.

8. The apparatus of claim 1, further comprising an activation device for selectively activating the sound wave source.

9. The apparatus of claim 1, further comprising a rechargeable battery.

10. The apparatus of claim 1, further comprising a data processing device.

11. The apparatus of claim 10, further comprising a memory device.

12. The apparatus of claim 10, further comprising a user interface including a display screen.

13. The apparatus of claim 12, wherein the apparatus is configured to display at least one data output on the display screen selected from the group of:
a. insulation density measurement,
b. an insulation density variation between a first insulation density measurement and a second insulation density measurement,
c. an insulation density variation between an insulation density measurement and a preselected insulation density target;
d. a running average of insulation density measurement taken during a defined time period;
e. a running average of insulation density measurement taken during a defined number of insulation density measurements;
f. a number of insulation density measurements taken during a defined time period;
g. a battery charge level;
h. a date and time associated with insulation density measurement;
i. an insulation density target; and
j. a GPS location associated with insulation density measurement.

14. The apparatus of claim 1, further comprising a global positioning system (GPS) receiver.

15. The apparatus of claim 1, further comprising a printing device.

16. The apparatus of claim 15, wherein the printing device is configured to print at least one at least one data output on a medium selected from the group of:
a. insulation density measurement,
b. an insulation density variation between a first insulation density measurement and a second insulation density measurement,
c. an insulation density variation between an insulation density measurement and a preselected insulation density target;
d. a running average of insulation density measurement taken during a defined time period;
e. a running average of insulation density measurement taken during a defined number of insulation density measurements;
f. a number of insulation density measurements taken during a defined time period;
g. a battery charge level;
h. a date and time associated with insulation density measurement;
i. an insulation density target; and
j. a GPS location associated with insulation density measurement.

17. A method for measuring the density of insulation in a cavity, comprising the steps of:
inserting a sound wave communicating probe and a sound wave receiving probe into the insulation in the cavity; wherein a gap is present between the sound wave communicating probe and the sound wave receiving probe when the probes are located in the insulation within the cavity;
activating a sound wave source to emit a sound wave that is transmitted to the sound wave communicating probe;
directing the sound wave from the sound wave communicating probe across the gap to the sound wave receiving probe; wherein the sound wave travels through the insulation that is present in the gap between the sound wave communicating probe and the sound wave receiving probe;
detecting the sound wave that is received by the sound wave receiving probe with the sound wave detector;
calculating a sound wave attenuation value corresponding to the attenuation of the sound wave traversing the gap between the sound wave communicating probe and the sound wave receiving probe by comparing the sound wave emitted from sound wave source to the sound wave detected by sound wave detector.

18. The method of claim 17, further comprising the step of calculating the density of insulation using the sound wave attenuation value.

19. (canceled)

20. An apparatus for determining the density of insulation in a cavity, the apparatus comprising:
a sound transceiver device for emitting a sound wave and detecting a sound wave;
wherein the sound transceiver device is configured to emit a sound wave that travels through insulation in the cavity and reflects off of an interior surface of cavity;
wherein the sound transceiver device is configured to detect the sound wave reflected off of the interior surface of cavity; and
a measuring device configured to determine a time period value corresponding to the time it takes the sound wave to travel from the sound transceiver device to the interior surface of the cavity off of which it is reflected and back to the sound transceiver device.

21. The apparatus of claim 20, wherein the apparatus calculates the density of insulation using the value of the time period value.

22-33. (canceled)
